(19) United States
(12) Patent Application Publication
(10) Pub. No.: US 2008/0031333 A1
(43) Pub. Date: Feb. 7, 2008

(54) Motion compensation module and methods for use therewith

(76) Inventors: Xinghai Billy Li, North York (CA); Xu Gang Wilf Zhao, Toronto (CA); Gang Qiu, Richmond Hill (CA)

Correspondence Address: GARLICK HARRISON & MARKISON, P.O. BOX 160727, AUSTIN, TX, 78716-0727, US

(21) Appl. No.: 11/498,398

(22) Filed: Aug. 2, 2006

(51) Int. Cl. H04N 11/02; H04N 11/04

(52) U.S. Cl. 375/240.16; 375/240.24

(57) ABSTRACT

A motion compensation module, that can be used in a video encoder for encoding a video input signal, includes a motion search module that generates a motion search motion vector for each macroblock of a plurality of macroblocks in a row of the input signal. A motion refinement module generates a refined motion vector for each macroblock of the plurality of macroblocks, based on the motion search motion vector. The motion search module and the motion refinement module are pipelined and operate to process each of the plurality of macroblocks in the row of the video input signal, in parallel.

### TECHNICAL FIELD OF THE INVENTION

The present invention relates to motion compensation and related methods used in devices such as video encoders/codecs.

### DESCRIPTION OF RELATED ART

Video encoding has become an important issue for modern video processing devices. Robust encoding algorithms allow video signals to be transmitted with reduced bandwidth and stored in less memory. However, the accuracy of these encoding methods face the scrutiny of users that are becoming accustomed to greater resolution and higher picture quality. Standards have been promulgated for many encoding methods including the H.264 standard that is also referred to as MPEG-4, part 10 or Advanced Video Coding, (AVC). While this standard sets forth many powerful techniques, further improvements are possible to improve the performance and speed of implementation of such methods.

Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of a various video processing devices in accordance with embodiments of the present invention.

FIG. 4 presents a block diagram representation of a video processing device 125 in accordance with an embodiment of the present invention.

FIG. 5 presents a block diagram representation of a video encoder 102 that includes motion compensation module 150 in accordance with an embodiment of the present invention.

FIG. 6 presents a graphical representation that shows example macroblock partitioning in accordance with an embodiment of the present invention.

FIG. 7 presents a graphical representation of a plurality of macroblocks of a video input signal that show neighboring macroblocks that can be used in determining a predicted motion vector in accordance with an embodiment of the present invention.

FIG. 8 presents a flowchart representation of a method in accordance with an embodiment of the present invention.

FIG. 9 presents a flowchart representation of a method in accordance with an embodiment of the present invention.

### DETAILED DESCRIPTION OF THE INVENTION INCLUDING THE PRESENTLY PREFERRED EMBODIMENTS

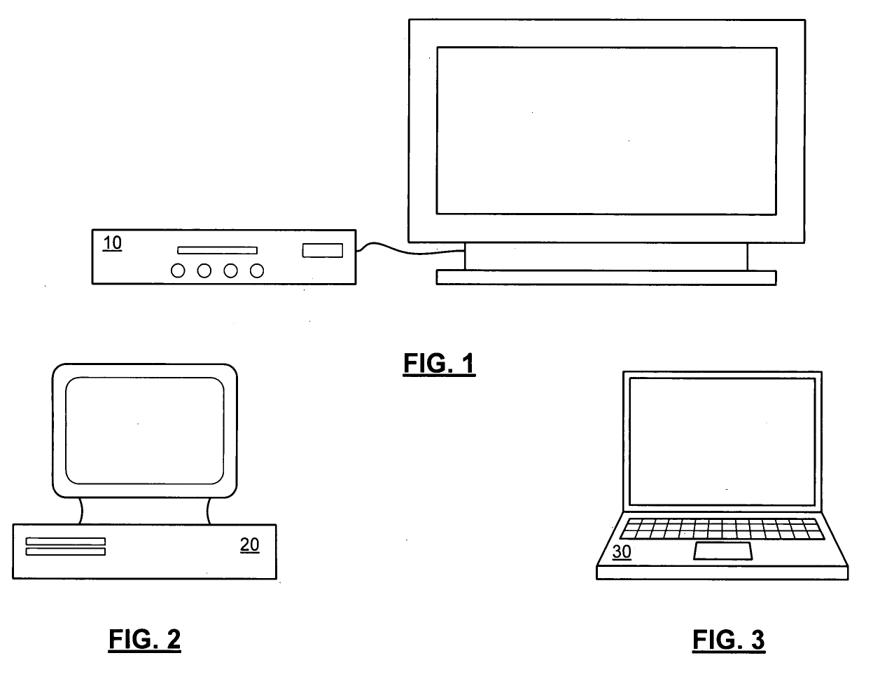

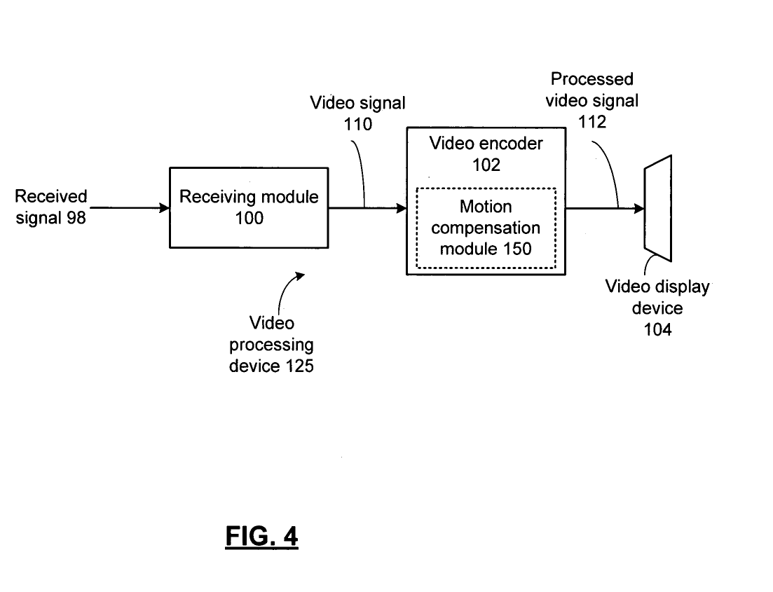

FIGS. 1-3 present pictorial diagram representations of a various video processing devices in accordance with embodiments of the present invention. In particular, set top box 10 with built-in digital video recorder functionality or a stand alone digital video recorder, computer 20 and portable computer 30 illustrate electronic devices that incorporate a video processing device 125 that includes one or more features or functions of the present invention. While these particular devices are illustrated, video processing device 125 includes any device that is capable of encoding video content in accordance with the methods and systems described in conjunction with FIGS. 4-9 and the appended claims.

FIG. 4 presents a block diagram representation of a video processing device 125 in accordance with an embodiment of the present invention. In particular, video processing device 125 includes a receiving module 100, such as a television receiver, cable television receiver, satellite broadcast receiver, broadband modern, 3G transceiver or other information receiver or transceiver that is capable of receiving a received signal 98 and extracting one or more video signals 110 via time division demultiplexing, frequency division demultiplexing or other demultiplexing technique. Video encoding module 102 is coupled to the receiving module 100 to encode or transcode the video signal in a format corresponding to video display device 104.

In an embodiment of the present invention, the received signal 98 is a broadcast video signal, such as a television signal, high definition televisions signal, enhanced high definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include an analog video signal that is formatted in any of a number of video formats including National Television Systems Committee (NTSC), Phase Alternating Line (PAL) or Sequentiel Couleur Avec Memoire (SECAM). Processed video signal includes 112 a digital video codec standard such as H.264, MPEG-4 Part 10 Advanced Video Coding (AVC) or other digital format such as a Motion Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary.

Video display devices 104 can include a television, monitor, computer, handheld device or other video display device that creates an optical image stream either directly or indirectly, such as by projection, based on decoding the processed video signal 112 either as a streaming video signal or by playback of a stored digital video file.

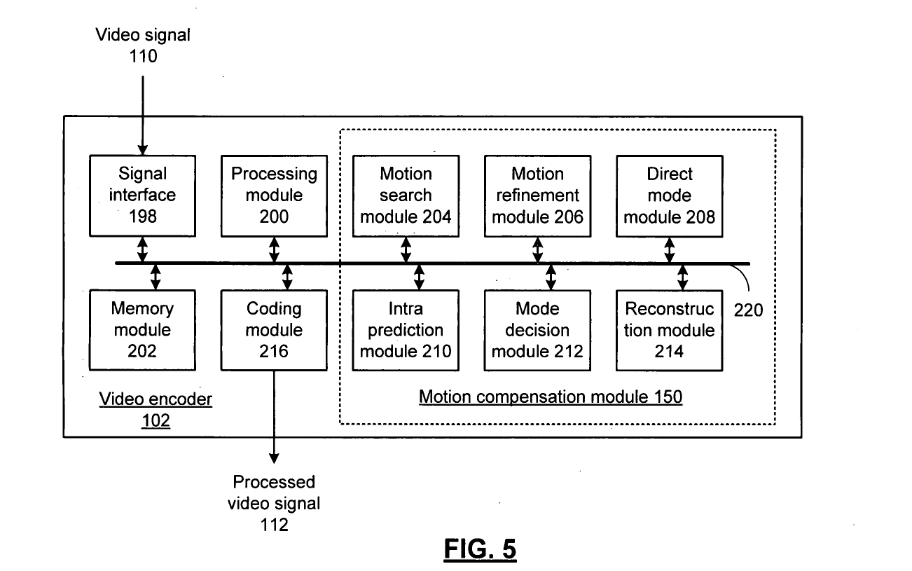

Video encoder 102 includes a motion compensation module 150 that operates in accordance with the present invention and, in particular, includes many optional functions and features described in conjunction with FIGS. 5-9 that follow.

FIG. 5 presents a block diagram representation of a video encoder 102 that includes motion compensation module 150 in accordance with an embodiment of the present invention. In particular, video encoder 102 operates in accordance with many of the functions and features of the H.264 standard, the MPEG-4 standard, VC-1 (SMPTE standard 421M) or other standard, to encode a video input signal 110 that is converted to a digital format via a signal interface 198.

The video encoder 102 includes a processing module 200 that can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 200, and memory module 202 are coupled, via bus 220, to the signal interface 198 and a plurality of other modules, such as motion search module 204, motion refinement module 206, direct mode module 208, intra-prediction module 210, mode decision module 212, reconstruction module 214 and coding module 216. The modules of video encoder 102 can be implemented in software, firmware or hardware, depending on the particular implementation of processing module 200. It should also be noted that the software implementations of the present invention can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present invention.

Motion compensation module 150 includes a motion search module 204 that processes pictures from the video input signal 110 based on a segmentation into macroblocks of pixel values, such as of 16 pixels by 16 pixels size, from the columns and rows of a frame and/or field of the video input signal 110. In an embodiment of the present invention, the motion search module determines, for each macroblock or macroblock pair of a field and/or frame of the video signal a motion vector that represents the displacement of the macroblock from a reference frame or reference field of the video signal to a current frame or field. In operation, the motion search module operates within a search range to locate a macroblock in the current frame or field to an integer pixel level accuracy such as to a resolution of 1-pixel. Candidate locations are evaluated based on a cost formulation to determine the location and corresponding motion vector that have a most favorable (such as lowest) cost.

In an embodiment of the present invention, a cost formulation is based on the sum of the Sum of Absolute Difference (SAD) between the reference macroblock and candidate macroblock pixel values and a weighted rate term that represents the number of bits required to be spent on coding the difference between the candidate motion vector and an estimated predicted motion vector that is determined based on motion vectors from neighboring macroblocks of a prior row of the video input signal—and not based on motion vectors from neighboring macroblocks of the row of the current macroblock. Because the cost formulation avoids the use of motion vectors from the current row, the motion search module can operate on an entire row of video input signal 110 in parallel, to contemporaneously determine the motion search motion vector for each macroblock in the row.

A motion refinement module 206 generates a refined motion vector for each macroblock of the plurality of macroblocks, based on the motion search motion vector. In an embodiment of the present invention, the motion refinement module determines, for each macroblock or macroblock pair of a field and/or frame of the video input signal 110 a refined motion vector that represents the displacement of the macroblock from a reference frame or reference field of the video signal to a current frame or field. In operation, the motion refinement module refines the location of the macroblock in the current frame or field to a greater pixel level accuracy such as to a resolution of ¼-pixel. Candidate locations are also evaluated based on a cost formulation to determine the location and refined motion vector that have a most favorable (such as lowest) cost. As in the case with the motion search module, a cost formulation is based on the a sum of the Sum of Absolute Difference (SAD) between the reference macroblock and candidate macroblock pixel values and a weighted rate term that represents the number of bits required to be spent on coding the difference between the candidate motion vector and an estimated predicted motion vector that is calculated based on motion vectors from neighboring macroblocks of a prior row of the video input signal—and not based on motion vectors from neighboring macroblocks of the row of the current macroblock. Because the cost formulation avoids the use of motion vectors from the current row, the motion refinement module can operate on an entire row of video input signal 110 in parallel, to contemporaneously determine the refined motion vector for each macroblock in the row. In this fashion the motion search module 204 and the motion refinement module 206 are pipelined and operate in parallel to process each of the plurality of macroblocks in the row of the video input signal 110.

A direct mode module 208 generates a direct mode motion vector for each macroblock of the plurality of macroblocks, based on a plurality of macroblocks that neighbor the macroblock of pixels. In an embodiment of the present invention, the direct mode module 208 operates in a fashion such as defined by the H.264 standard to determine the direct mode motion vector and the cost associated with the direct mode motion vector.

While the prior modules have focused on inter-prediction of the motion vector, intra-prediction module 210 generates a best intra prediction mode for each macroblock of the plurality of macroblocks. In particular, intra-prediction module 210 operates in a fashion such as defined by the H.264 standard to evaluate a plurality of intra prediction modes to determine the best intra prediction mode and the associated cost.

A mode decision module 212 determines a final motion vector for each macroblock of the plurality of macroblocks based on costs associated with the refined motion vector, the direct mode motion vector, and the best intra prediction mode, and in particular, the method that yields the most favorable (lowest) cost, or otherwise an acceptable cost. A reconstruction module 214 generates residual luma and chroma pixel values corresponding to the final motion vector for each macroblock of the plurality of macroblocks.

A coding module 216 of video encoder 102 generates processed video signal 112 by transforming coding and quantizing the motion vector and residual pixel values into quantized transformed coefficients that can be further coded, such as by entropy coding, to be transmitted and/or stored as the processed video signal 112.

While not expressly shown, video encoder 102 can include a memory cache, a memory management module, a filter module, such as an in-loop deblocking filter, comb filter or other video filter, and/or other module to support the encoding of video input signal 110 into processed video signal 112.

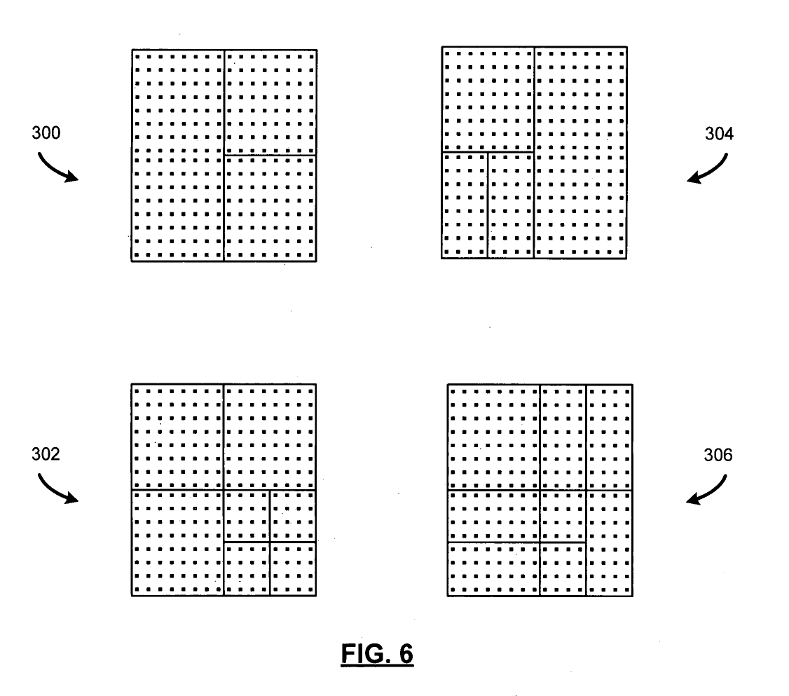

FIG. 6 presents a graphical representation that shows example macroblock partitioning in accordance with an embodiment of the present invention. In particular, while the modules described in conjunction with FIG. 5 above can operate on macroblocks having a size such as 16 pixels×16 pixels, such as in accordance with the H.264 standard, macroblocks can be partitioned into subblocks of smaller size, as small as 4 pixels on a side with the functions and features described in conjunction with the macroblocks applying to each subblock with individual pixel locations indicated by dots. Macroblocks 300, 302, 304 and 306 represent examples of such partitioning into subblocks. In particular, macroblock 300 is a 16×16 macroblock that is partitioned into an 8×16 subblock and two 8×8 subblocks. Macroblock 302 is a 16×16 macroblock that is partitioned into three 8×8 subblocks and four 4×4 subblocks. Macroblock 304 is a 16×16 macroblock that is partitioned into an 8×16 subblock, an 8×8 subblock and two 4×8 subblocks. Macroblock 306 is a 16×16 macroblock that is partitioned into an 8×8 subblock, three 4×8 subblocks, two 8×4 subblocks, and two 4×4 subblocks. The partitioning of the macroblocks into smaller subblocks increases the complexity of the motion compensation by requiring various compensation methods, such as the motion search to determine, not only the motion search motion vectors for each subblock, but the best motion vectors over the set of all possible partitions of a particular macroblock. The result however can yield more accurate motion compensation and reduced compression artifacts in the decoded video image.

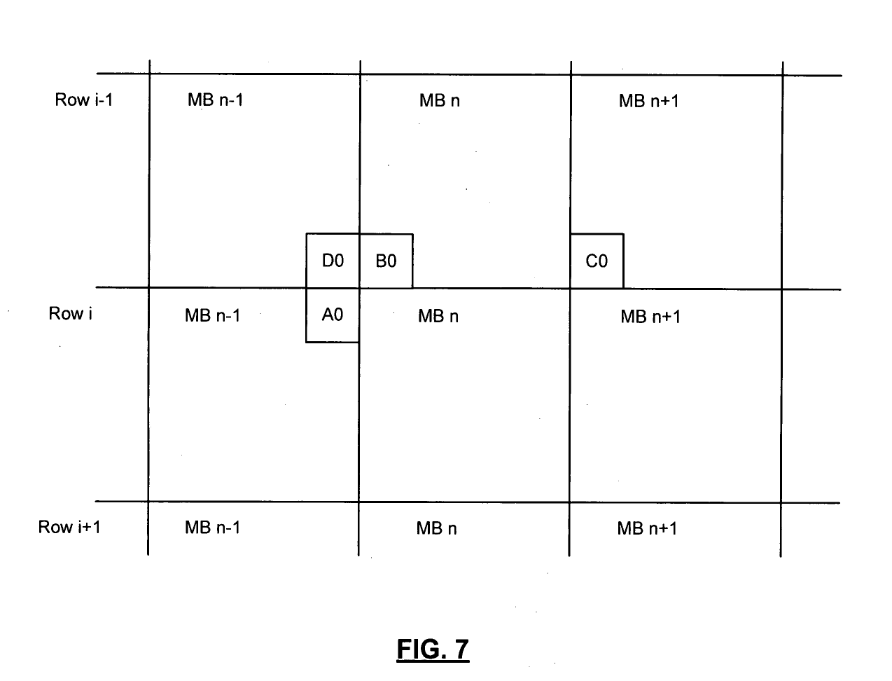

FIG. 7 presents a graphical representation of a plurality of macroblocks of a video input signal that show the use of neighboring macroblocks in determining an estimated predicted motion vector in accordance with an embodiment of the present invention. Three macroblocks MB n−1, MB n and MB n+1 are show for three rows, row i-1, row i and row i+1 of a video input signal. The dots representing individual pixel locations have been omitted for clarity. In a conventional methodology, the predicted motion vector for MB n of row i would be based on the final motion vectors 4×4 determined for subblock D0 from MB n-1 of row i-1, subblock B0 from row i-1, subblock C0 from MB n+1 of row i-1 along with subblock A0 from MB n-1 of row i. However, this approach would require any calculations for MB n to wait for the the final results for MB n-1 that contains subblock A0.

In an embodiment of the present invention, the cost associated with the refined motion vector and the motion search motion vector for a macroblock is calculated based on an estimated predicted motion vector that is based exclusively on neighboring macroblocks from at least one prior row of the video input signal. In the example presented above, the estimated predicted motion vector for MB n of row is calculated based on subblocks D0, B0 and C0 from the row above (without including subblock A0 from the current row). In this fashion, the estimated predicted motion vector for each of the macroblocks in row i can be calculated based exclusively on final motion vectors for subblocks from another row, such as the prior row. As discussed in conjunction with FIG. 5, this allows the motion search module and motion refinement module to be pipelined and to operate in parallel on an entire row at a time.

In a further embodiment of the present invention, the estimated predicted motion vector used to calculate a cost for either a motion search motion vector or a refined motion vector for one of the plurality of subblocks of a macroblock is used for each of the remaining plurality of subblocks. For example, the cost calculation used for each subblock of MB n of row i would be the estimated predicted motion vector that is based on subblocks D0, B0 and C0 from row i-1.

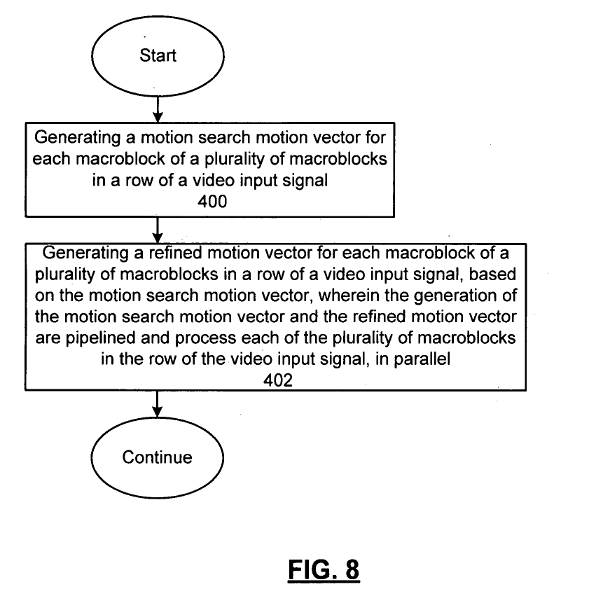

FIG. 8 presents a flowchart representation of a method in accordance with an embodiment of the present invention. In particular, a method is presented for use in conjunction with one or more of the features and functions described in association with FIGS. 1-7. In step 400, a motion search motion vector is generated for each macroblock of a plurality of macroblocks in a row of the input signal. In step 402, a refined motion vector for each macroblock of the plurality of macroblocks is generated, based on the motion search motion vector, wherein the generation of the motion search motion vector and the generation of the refined motion search vector are pipelined and operate to process each of the plurality of macroblocks in the row of the video input signal, in parallel.

In an embodiment of the present invention, step 402 includes calculating a cost based on an estimated predicted motion vector that is based exclusively on neighboring macroblocks from at least one prior row of the video input signal. The prior row can include the row above the row of the video input signal. Further, step 402 optionally includes evaluating a plurality of partitions of each macroblock of the plurality of macroblocks into a plurality of subblocks and wherein the estimated predicted motion vector used to calculate a cost for one of the plurality of subblocks is used for each of the remaining plurality of subblocks.

In an embodiment of the present invention, step 400 includes calculating a cost based on an estimated predicted motion vector that is based exclusively on neighboring macroblocks from a prior row of the video input signal. The prior row can include the row above the row of the video input signal. Further, step 400 optionally includes evaluating a plurality of partitions of each macroblock of the plurality of macroblocks into a plurality of subblocks and wherein the estimated predicted motion vector used to calculate a cost for one of the plurality of subblocks is used for each of the remaining plurality of subblocks.

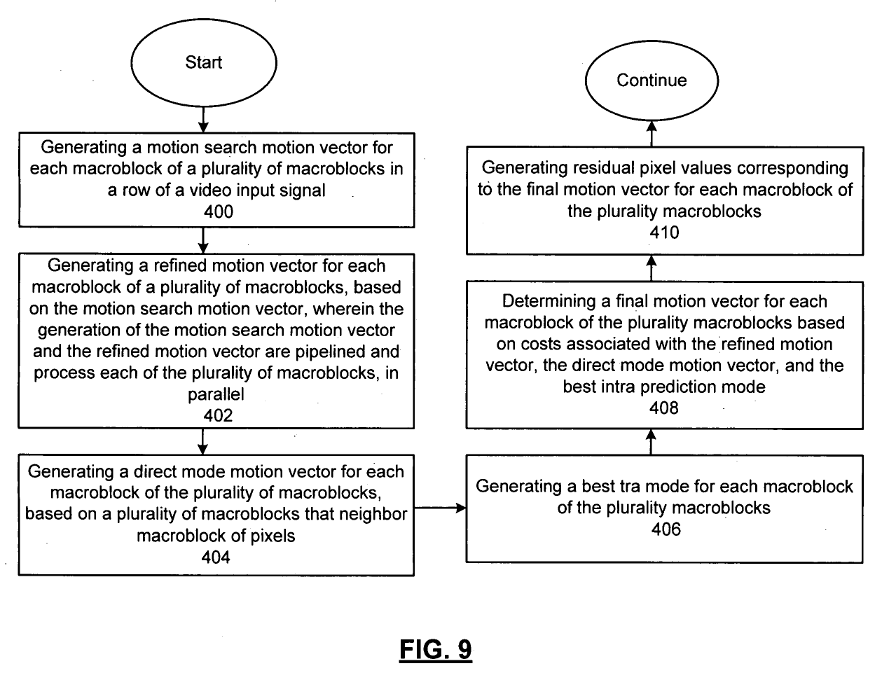

FIG. 9 presents a flowchart representation of a method in accordance with an embodiment of the present invention. A method is presented for use in conjunction with one or more of the features and functions described in association with FIGS. 1-8. In particular, a method is presented that includes steps from FIG. 8 that are referred to by common reference numerals. In addition, this method includes step 404 of generating a direct mode motion vector for each macroblock of the plurality of macroblocks, based on a plurality of macroblocks that neighbor the macroblock of pixels. In step 406, a best intra prediction mode is generated for each macroblock of the plurality of macroblocks. In step 408, a final motion vector is determined for each macroblock of the plurality of macroblocks based on costs associated with the refined motion vector, the direct mode motion vector, and the best intra prediction mode. In step 410 residual pixel values are generated corresponding to the final motion vector for each macroblock of the plurality of macroblocks.

In preferred embodiments, the various circuit components are implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a video encoder and motion compensation module for use therewith. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A motion compensation module for use in a video encoder for encoding a video input signal, the motion compensation module comprising:
a motion search module, that generates a motion search motion vector for each macroblock of a plurality of macroblocks;
a motion refinement module, coupled to the motion search module, that generates a refined motion vector for each macroblock of the plurality of macroblocks, based on the motion search motion vector;
a direct mode module, that generates a direct mode motion vector for each macroblock of the plurality of macroblocks, based on a plurality of macroblocks that neighbor the macroblock of pixels;
an intra-prediction module that generates a best intra prediction mode for each macroblock of the plurality of macroblocks;
a mode decision module, coupled to the motion refinement module, the direct mode module and the prediction module, that determines a final motion vector for each macroblock of the plurality of macroblocks based on costs associated with the refined motion vector, the direct mode motion vector, and the best intra prediction mode; and
a reconstruction module, coupled to the mode decision module, that generates residual pixel values corresponding to the final motion vector for each macroblock of the plurality of macroblocks;
wherein the motion search module and the motion refinement module are pipelined and operate in parallel to process each of the plurality of macroblocks in the row of the video input signal.

2. The motion compensation module of claim 1 wherein the cost associated with the refined motion search is calculated based on an estimated predicted motion vector that is based exclusively on neighboring macroblocks from at least one prior row of the video input signal.

3. The motion compensation module of claim 2 wherein the at least one prior row includes the row above the row of the video input signal.

4. The motion compensation module of claim 2 wherein the motion refinement module evaluates a plurality of partitions of each macroblock of the plurality of macroblocks into a plurality of subblocks and wherein the estimated predicted motion vector used to calculate a cost for one of the plurality of subblocks is used for each of the remaining plurality of subblocks.

5. The motion compensation module of claim 1 wherein the motion search motion vector is determined based on a cost calculated based on an estimated predicted motion vector that is based exclusively on neighboring macroblocks from a prior row of the video input signal.

6. The motion compensation module of claim 5 wherein the at least one prior row includes the row above the row of the video input signal.

7. The motion compensation module of claim 5 wherein the motion search module evaluates a plurality of partitions of each macroblock of the plurality of macroblocks into a plurality of subblocks and wherein the estimated predicted motion vector used to calculate a cost for one of the plurality of subblocks is used for each of the remaining plurality of subblocks.

8. A motion compensation module for use in a video encoder for encoding a video input signal, the motion compensation module comprising:
a motion search module, that generates a motion search motion vector for each macroblock of a plurality of macroblocks in a row of the input signal; and
a motion refinement module, coupled to the motion search module, that generates a refined motion vector for each macroblock of the plurality of macroblocks, based on the motion search motion vector;
wherein the motion search module and the motion refinement module are pipelined and operate to process each of the plurality of macroblocks in the row of the video input signal, in parallel.

9. The motion compensation module of claim 8 further comprising:
a direct mode module, that generates a direct mode motion vector for each macroblock of the plurality of macroblocks, based on a plurality of macroblocks that neighbor the macroblock of pixels;
an intra-prediction module that generates a best intra prediction mode for each macroblock of the plurality of macroblocks; and
a mode decision module, coupled to the motion refinement module, the direct mode module and the prediction module, that determines a final motion vector for each macroblock of the plurality of macroblocks based on costs associated with the refined motion vector, the direct mode motion vector, and the best intra prediction mode.

10. The motion compensation module of claim 9 further comprising:
a reconstruction module, coupled to the mode decision module, that generates residual pixel values corresponding to the final motion vector for each macroblock of the plurality of macroblocks.

11. The motion compensation module of claim 8 wherein motion refinement module calculates a cost associated with the refined motion vector based on an estimated predicted motion vector that is based exclusively on neighboring macroblocks from at least one prior row of the video input signal.

12. The motion compensation module of claim 11 wherein the at least one prior row includes the row above the row of the video input signal.

13. The motion compensation module of claim 11 wherein the motion refinement module evaluates a plurality of partitions of each macroblock of the plurality of macroblocks into a plurality of subblocks and wherein the estimated predicted motion vector used to calculate a cost for one of the plurality of subblocks is used for each of the remaining plurality of subblocks.

14. The motion compensation module of claim 8 wherein the motion search motion vector is determined based on a cost calculated based on an estimated predicted motion vector that is based exclusively on neighboring macroblocks from a prior row of the video input signal.

15. The motion compensation module of claim 14 wherein the at least one prior row includes the row above the row of the video input signal.

16. The motion compensation module of claim 14 wherein the motion search module evaluates a plurality of partitions of each macroblock of the plurality of macroblocks into a plurality of subblocks and wherein the estimated predicted motion vector used to calculate a cost for one of the plurality of subblocks is used for each of the remaining plurality of subblocks.

17. A method for use in a video encoder for encoding a video input signal, method comprising:
generating a motion search motion vector for each macroblock of a plurality of macroblocks in a row of the input signal; and
generating a refined motion vector for each macroblock of the plurality of macroblocks, based on the motion search motion vector;
wherein the generation of the motion search motion vector and the generation of the refined motion search vector are pipelined and operate to process each of the plurality of macroblocks in the row of the video input signal, in parallel.

18. The method of claim 17 further comprising:
generating a direct mode motion vector for each macroblock of the plurality of macroblocks, based on a plurality of macroblocks that neighbor the macroblock of pixels;
generating a best intra prediction mode for each macroblock of the plurality of macroblocks; and
determining a final motion vector for each macroblock of the plurality of macroblocks based on costs associated with the refined motion vector, the direct mode motion vector, and the best intra prediction mode.

19. The method of claim 18 further comprising:
generating residual pixel values corresponding to the final motion vector for each macroblock of the plurality of macroblocks.

20. The method of claim 17 wherein the step of generating a refined motion vector includes calculating a cost based on an estimated predicted motion vector that is based exclusively on neighboring macroblocks from at least one prior row of the video input signal.

21. The method of claim 20 wherein the at least one prior row includes the row above the row of the video input signal.

22. The method of claim 20 wherein the step of generating a refined motion vector includes evaluating a plurality of partitions of each macroblock of the plurality of macroblocks into a plurality of subblocks and wherein the estimated predicted motion vector used to calculate a cost for one of the plurality of subblocks is used for each of the remaining plurality of subblocks.

23. The method of claim 17 wherein the step of generating a motion search motion vector includes calculating a cost based on an estimated predicted motion vector that is based exclusively on neighboring macroblocks from a prior row of the video input signal.

24. The method of claim 23 wherein the at least one prior row includes the row above the row of the video input signal.

25. The method of claim 23 wherein the step of generating a motion search motion vector includes evaluating a plurality of partitions of each macroblock of the plurality of macroblocks into a plurality of subblocks and wherein the estimated predicted motion vector used to calculate a cost for one of the plurality of subblocks is used for each of the remaining plurality of subblocks.
